(19) United States
(12) Patent Application Publication
(10) Pub. No.: US 2006/0143450 A1
(43) Pub. Date: Jun. 29, 2006

(54) Method and apparatus for authenticating a password

(76) Inventors: Narendranath Airody Udupa, Bangalore (IN); Bijo Thomas, Kottayam (IN)

Correspondence Address: PHILIPS INTELLECTUAL PROPERTY & STANDARDS, P.O. BOX 3001, BRIARCLIFF MANOR, NY, 10510, US

(21) Appl. No.: 10/560,685

(22) PCT Filed: Jun. 15, 2004
(86) PCT No.: PCT/IB04/50907

§ 371 Date: Dec. 14, 2005

(30) Foreign Application Priority Data
Jun. 13, 2003 (EP) 03101791.6

(51) Int. Cl. H04L 9/00

(52) U.S. Cl. 713/168

(57) ABSTRACT

A password formed of several fields (101-105) is presentable in a series of instances (100, 110, 120, 130). The fields include at least one of (a) a static field (105) that does not change upon each instance of the password and (b) a dynamic field (101, 102) that changes with each instance of the password based upon extrinsic data. Further, there is a “hysteresis” field (or a “dynamic field with history”, 103, 104) which contains data that is a function of a preceding instance of the password. When a current presented instance (110) of the password is input/received, a comparison operation is performed in which the hysteresis field (113, 114) of the current presented instance of the password is compared using data retained since a prior instance of authentication of the password (101, 102).

This invention relates to a method of authenticating a password, and apparatus and software for password authentication, for example for authentication of credit card transactions or for hardware or website log-in.

Electronic commerce is predicted to be one of the major reasons for people to use the Internet. At present, the major obstacle to the expansion of online transaction is the security problem with credit cards and passwords being exposed because of the open characteristics of TCP/IP. The major causes of credit card problems are theft and illegal copying of credit cards. These are directly related to the problems with the current password system used by credit cards.

Many companies have tried to find ways to provide security solutions for credit card and online transactions. Often hardware solutions are proposed, but these are expensive and still imperfect, as they may be copied and hacked. In addition, any data flowing on the Internet whether encrypted or not can be caught by someone else and may be reused. Encryption is useful so that people cannot understand the encrypted data, but, technologically, any encrypted data may be reused “as is” on the Internet.

A dynamic password algorithm has been described by Choonyeol Yu in Nikkei Electronics Asia, April 2000, as a software solution to be implemented into computer systems for credit card security by simply changing the password algorithm. Whereas prior systems allowed a password entered using the same alphanumeric figures each time, the described system is dynamic so that the password changes automatically according to when and where the credit card is used. The password is set utilizing the characteristics of variables which change according to the points in time and/or points in location, etc. Points in time include year, month, date, hour, minute, second, even nanosecond, etc; while points in location include area code, zip code, host IP address, company name, etc.

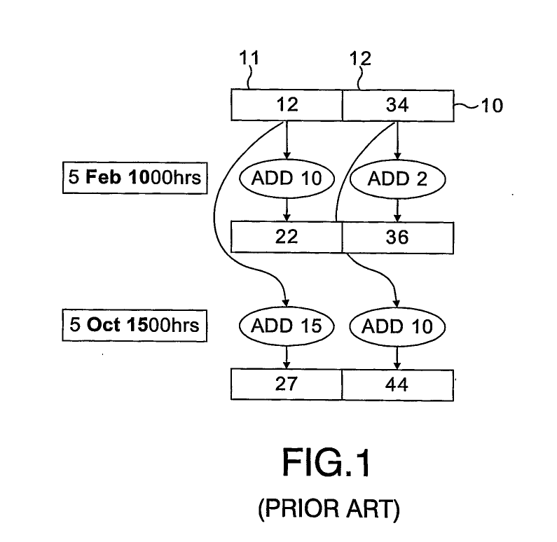

The actual numeric number to be entered on the time and date when connecting to a banking server is to be calculated as: “Static password (x+) variables. FIG. 1 illustrates the methods for setting the password and its usage. Referring to that figure, a master password 10 is shown having a first part (or field) 11 and a second part (or field) 12. By way of example, the master password is set at 1234. The parts of the master password will be linked with variable factors to determine the actual password to be entered at a given time. In this example, the first part 11 will be linked with a time factor in hours and the second part 12 will be linked with a time factor in months. Thus, for example, when a user wishes to enter a password on 5 February at 10 o'clock, the hour factor is 10 and the month factor is 2 (for February). These factors are added to the respective parts of the password, so that the actual password to be entered at that time on that day will be 2236. Similarly, at 15:00 hours on 5 October, the password to be entered will be 2746.

The above technology relieves the user of the worry that the password may be caught by someone else beside the user at the bank, or on the Internet by a hacker. It remains a problem, however, that security could be at risk if a fraudster or hacker were to gain knowledge of the master password as well as the scheme by which subsequent passwords are generated. Additional security measures would be advantageous.

It is an object of the present invention to provide additional security preventing a password from being reused by a recipient or by an eavesdropper.

According to a first aspect of the present invention, a method is provided of authenticating a password that is presentable in a series of instances and has a first set of fields and has a second field. The first set of fields comprises at least one of (a) a static field that does not change upon each instance of the password and (b) a dynamic field that changes with each instance of the password based upon extrinsic data. The second field (referred to herein as a “hysteresis field” or a “dynamic field with history”) is arranged to contain data that is a function of a preceding instance of the password (or data in a preceding instance of the password), and the method comprises receiving a current presented instance of the password, and performing a comparison operation in which the second field of the current presented instance of the password is compared using data retained since a prior instance of authentication of the password.

By these means, an instance of a password (or even the password and the algorithm for constructing a new password) is valid only for one use, and cannot be reused. A password can be shared for a single use while preventing the recipient from using it again. Knowledge of any schemes and necessary extrinsic data (like place or time) will not be sufficient to enable a new instance of the password to be generated.

The first set of fields preferably comprises a static field and a dynamic field.

For the dynamic field, the step of comparison may comprise receiving extrinsic data in the form of date and/or time and/or place data and/or machine IP address etc.

Upon successful comparison, data is retained for purposes of comparison of a next instance of the password. The data retained may comprises one of the date and the time of receipt of the instance of the current presented instance of the password and/or it may comprise at least a part of the current presented instance of the password. Additionally or in the alternative it is derived from the place of receipt of the instance of the current presented instance of the password (for example it may consist of the number of letters in a place name).

The step of comparing preferably includes generating at least the second field of a generated instance of the password and comparing the second field of the current presented instance of the password with the second field of the generated instance of the password.

In accordance with another aspect of the invention, apparatus is provided, such as a laptop computer, a personal digital assistant (PDA), or a client and server pair of devices, for receiving and authenticating a password that is presentable in a series of instances. The apparatus comprises input means for inputting a current presented instance of the password and comparison means for performing a comparison operation in which the hysteresis field (the dynamic field with history) of the current presented instance of the password is compared using data retained since a prior instance of authentication of the password.

In the case of a stand-alone device such as a laptop computer or a PDA, the input means may be a keyboard or keypad. In the case of a networked device, the input means may be another device on the network. In the latter case, where the input means and the comparison means are remotely located, encryption means may be provided for encrypting passwords being communicated from the input means to the comparison means.

A memory, preferably in the comparison means, retains data upon successful comparison, for purposes of comparison of a next instance of the password.

The invention as described and claimed may be provided in the form of a data carrier having instructions and data stored thereon. These instructions and data, as described in greater detail below, when loaded into the memory of a suitable computer, and when presented with a current presented instance of a password, cause the computer to perform a comparison operation in which the hysteresis field (the dynamic field with history) of the current presented instance of the password is compared using data retained since a prior instance of authentication of the password.

Further aspects and details of the preferred embodiments of the invention are now described, by way of example only, with reference to the drawings.

FIG. 1 illustrates a method of prior art dynamic password assignment scheme.

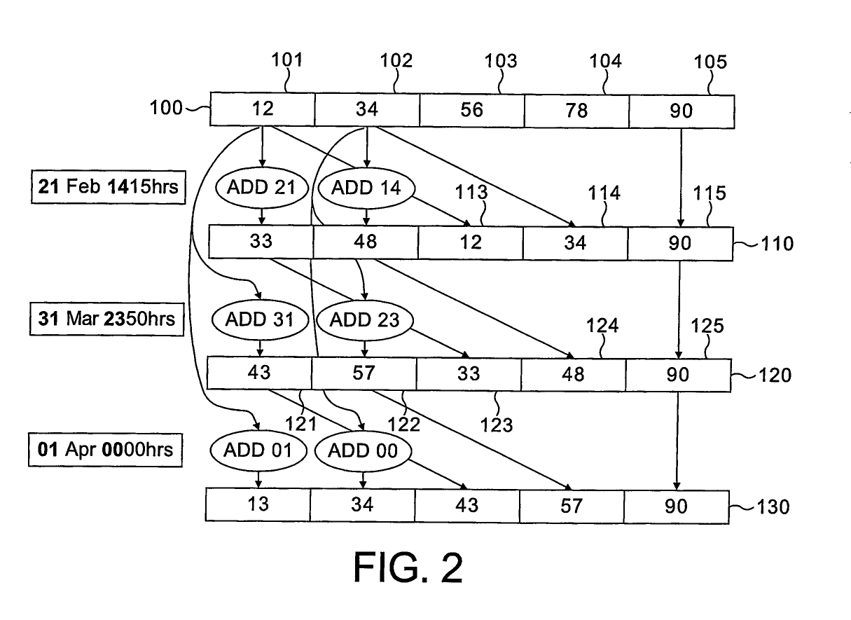

FIG. 2 illustrates a method of dynamic password assignment with hysteresis in accordance with a first embodiment of the present invention.

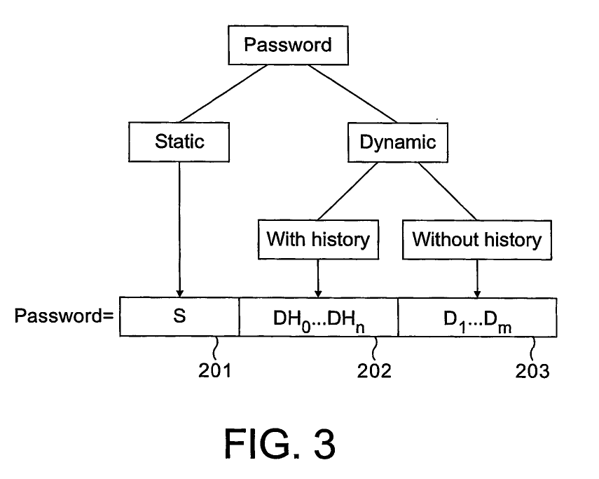

FIG. 3 illustrates the structure of a password having dynamic fields with history, in accordance with a second embodiment of the invention.

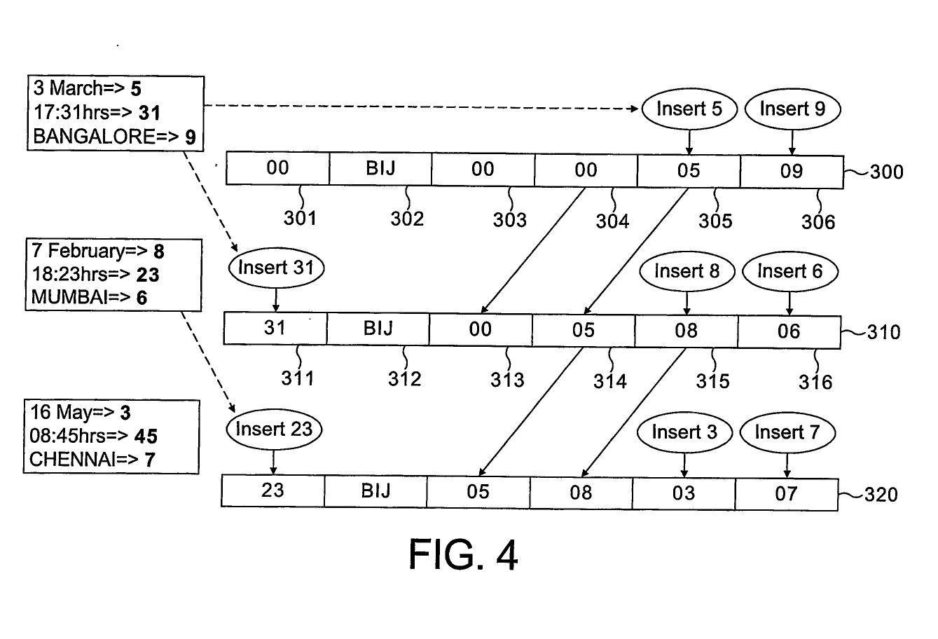

FIG. 4 illustrates the use of the password having dynamic fields with history, in accordance with the second embodiment of the invention.

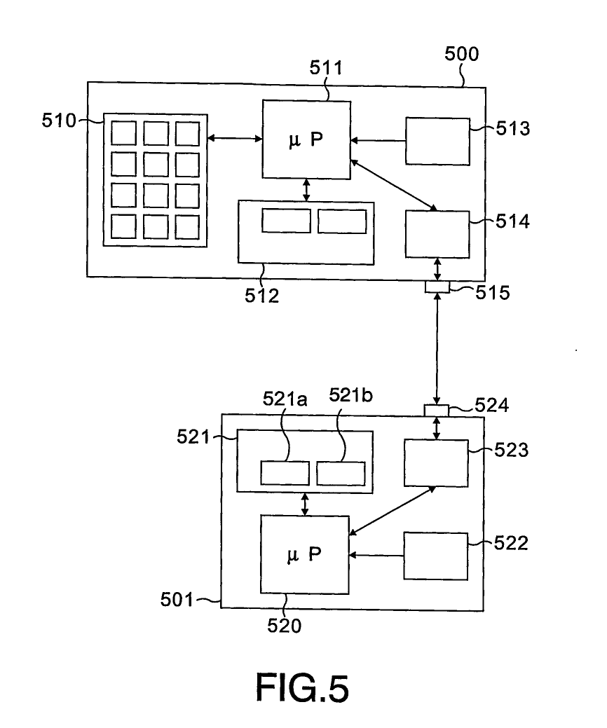

FIG. 5 illustrates a hardware device for receiving a password in accordance with the present invention.

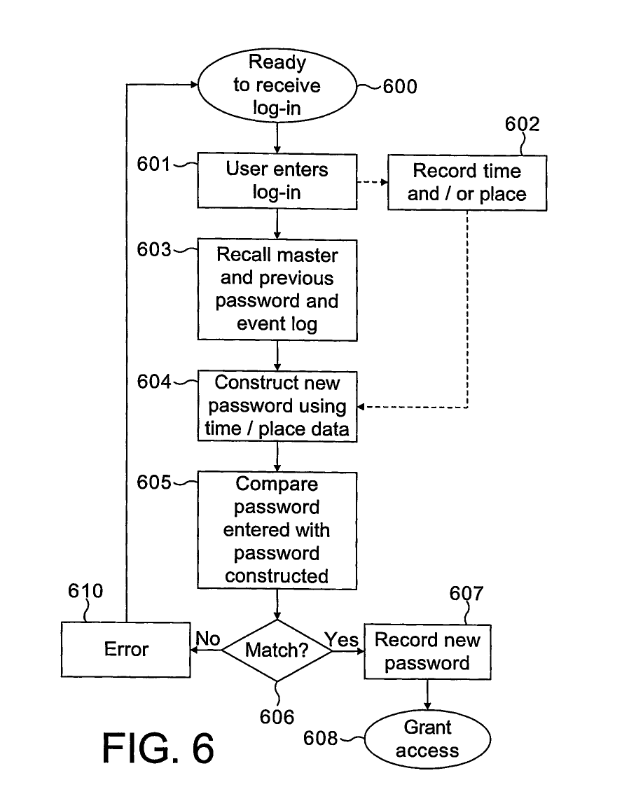

FIG. 6 is a flow diagram illustrating the operation of software in a device such as that of FIG. 5.

Referring to FIG. 2, a master password 100 is shown having five fields, 101 to 105. Field 101 is dynamic and is a date field. Field 102 is dynamic and is an hour field. Fields 103 and 104 are hysteresis fields, the first (field 103) being a previous date field and the second (field 104) being a previous hour field. Field 105 is a static field. Beneath master password 100, there is illustrated a current password 110, which is derived from the master password 100 as follows. The example is given where the password 110 is generated on 21 February at 1415 hours. In this instance, the example will use the day figure of the date and the hour figure of the time to modify the date field 101 and the hour field 102. In the example given, the master password is 1234567890.

The password 110 is generated on 21 February at 1415 hours by adding 21 to the value in field 101 to give 33 and by adding 14 to the value in field 102 to give 48. The ‘previous date’ field 113 takes its value from the date field 101 of the master password 100 (which in this case was the last valid password) and the ‘previous hour’ field 114 takes its value from the hour field 102 of the master password 100. The static field 115 does not change and takes the value 90 found in static field 105 of password 100. Thus, the new password is 3348123490.

Moving further down the figure, the third password 120 is generated in a similar manner. The date and hour fields 121 and 122 are derived from the date and hour fields of the master password 101 and 102 using the current date and current hour (i.e. the date and hour of entering of the new password). The ‘previous date’ fields 123 and ‘previous hour’ field 124 are derived from the date field and hour field, respectively, of the previous password 110. The method is repeated to generate a fourth password 130, again having fields derived from the master password 100 and fields derived from the previous password 120.

A major advantage of the arrangement described is that it has a “use once” feature, which makes it possible to share it with other people, without any concern of misuse. For example, if user A gives the password 110 to user B, together with the algorithm for its use, user B will be told to enter “date+12, hour+34, 123490”. Thus, if user B uses the password on 21 February at 1415 hours, user B will generate the password 3348123490 and have access to the protected account, equipment or domain, however, user B is not aware that fields 113, 114 and 115, i.e. the digits 123490 are not a static field. User B will not be able to use the password again, even if he attempts to use it on the same date at the same hour.

The user has to remember the date and time of the previous use in order to re-use the password. The user has to make a minor modification to the password after each use. This demands some extra mental effort on the part of the user, but the security is significantly enhanced.

As an alternative to using date and time, the place of last use can be entered into one of the fields 101 and 102. A simple way of entering this information is by counting the number of letters in the place name in the place of last use. If, for example, the place of last use is Bangalore, this has 9 letters and this figure will be added to the base figure in the master password.

Of course, the scheme can be made more complicated by adding additional fields (day, month, hour, place) or can be simplified by using fewer fields.

Turning to FIG. 3, the structure of a password in accordance with an alternative embodiment of the invention is illustrated. The password is divided into static and dynamic parts. The dynamic parts include dynamic parts with history and dynamic parts without history. Thus, there is a field 201 which is static, a series of fields 202 which are dynamic fields with history and a series of fields 203 which are dynamic fields without history.

The dynamic fields with history are updated using the following relations.
DH₀ of Pᵢ=F₀(Pᵢ₋₁, Eᵢ₋₁)
DH₁ of Pᵢ=F₁(Pᵢ₋₁, Eᵢ₋₁), . . . ,
DHₙ of Pᵢ=Fₙ(Pᵢ₋₁, Eᵢ₋₁).

Where Pᵢ, Pᵢ₋₁ are the current and previous passwords, respectively. Eᵢ₋₁ is the event record of previous log-in session such as time/date of log-in. F₀, F₁, . . . Fₙ are simple functions, i.e. there are n+1 memory (history) functions for DH₀ . . . DHₙ, each depending on a previous password (Pᵢ₋₁) and an event record of a previous log-in session (Eᵢ₋₁).

The dynamic fields without history are defmed using the following relations.
D₁=f₁(v₁, v₂, . . . )
D₂=f₂(v₁, v₂, . . . )
Dₘ=fₘ(v₁, v₂, . . . )

Where v₁, v₂, . . . are variables, which change according to the points in time, points in location, etc.

Use of this second embodiment will be described with reference to FIG. 4.

In FIG. 4, a master password is shown, having a first dynamic field with history (DH₀) 301 (which in this case is a time field), a static field 302, a second dynamic field with history (DH₁) 303, a third dynamic field with history (DH₂) 304, a first dynamic field without history (D₁) 305 and a second dynamic filed without history (D₂) 306.

When the master password 300 is generated, the dynamic fields with history (DH₀ to DH₂) are set at 0, because there is no history. The master password 300 is generated on 3 March at 1731 hours at Bangalore and the dynamic fields without history 305 and 306 are set using this data. In the present example, the algorithm uses the number of letters in the month and the number of letters in the place as the dynamic data. Thus, field 305 is set at 05 and field 306 is set at 09.

On the next occasion of use, password 310 needs to be generated. In this example, password 310 is to be generated on 7 February at 1823 hours in Mumbai. The function F₀ for generating field 311 requires that the user remembers the exact time of last entry of the password, e.g. using the event record of the previous login session. The minutes from the time field of the time of last entry are added to the field DH₀ in master password 300 (i.e. field 301). In this example, the master password was generated at 31 minutes past 5 in the afternoon, so field 311 is generated by inserting 31. (Note that field 311 could equally be generated by adding 31 to the value in the field 301 of the master password 300). Field 312 is the static field and is unchanged. Field 313, being a dynamic field with history, receives the historical value in field 304 of the previously valid password, which in this case is master password 300. Field 314 is also a dynamic field with history and uses the value from the previously valid field 305 of the previously valid password 300. Fields 315 and 316 are created as before by inserting the number of letters in the month (in this case the month is February and the value is 8) and the number of letters in the place name (in this case the place is Mumbai and the value is 6). Thus, password 310 is generated using fields from the previous password, information from the time of entry of the previous password and information from the time and place of entry of the present password.

A further password 320 can be generated at a later time and in a different place by a similar algorithm as illustrated. Again, it is necessary for the user to remember the exact time, to the nearest minute, at which the previous password was entered.

Of course, the functions F₀, F₁ . . . Fₙ, and f₁, f₂ . . . fₘ, can be more or less complicated than those used in the present example. For example, instead of having to remember the exact minute of entry of the last password, the day or month of entry of the last password, or the time of the present login could be used for field 311. Alternatively, as for the algorithm of FIG. 2, the fields 311, 315 and 316 can be generated by adding, rather than inserting values, i.e. adding a value to the value in the corresponding field of the master password.

The system that is to authenticate the password uses a password generation algorithm that mirrors the algorithm used by the user or a simplified algorithm. Referencing the example of FIG. 2, the authenticating system has a calendar and clock that is synchronized to the calendar and clock of the user, such that the authenticating system knows the date and hour at which the user is attempting to log-on, and all 5 fields of the password can be compared in any authentication.

Authentication can be used with encryption, whereby a key is passed to the user, the user encrypts the password and sends it to the system and the system decrypts the password before performing its comparison.

In the example given in FIG. 4, the system records the time of entry of password 300, in order to be ready to make a comparison of field 311 when password 310 is next entered. Means can be provided (described in greater detail below) whereby the authenticating system can identify the place of entry of the password and, thus, calculate the number of letters in the place of entry, in order to make a comparison of field 316 in password 310.

It is preferred that a comparison or verification is made of all fields entered. This avoids erroneous data propagating through to other fields and causing later login failures.

In another embodiment a password comprises a random hysteresis(RH) field and a random don't care (RD) field. The ‘random hysteresis’ field of the current password contans data that is a function of the random don't care field of the ‘previous’ password, and the ‘random don't care field’ of the current password is a random value. According to this embodiment a simple and secure solution for password authentication is provided. The random-hysteresis field can be expressed as a function F as follows
RH=F(RD′),
where RD′ is a random don't care field in a previous instance of the password.

The second field (“random don't care field”) is data, which is randomly entered by the user. This field is termed as a random don't care field because it can be any set of characters (whose length is limited to a maximum value), which is randomly entered by the user at a particular instance of the password. For the current instance of the password this field is considered as a ‘don't care’ field. This field will be used in a later instance of the password informing the RH field using the function F.

The master password 100 has two fields, the random-hysteresis field and the random don't care field. A current password 200 is derived from the master password 100 as follows. The master password 100 is having a random don't care field 12573. To construct the random-hysteresis field of the current password, the function is taken as F=abs(RD′−1111), as an example. Using this function the random-hysteresis field is calculated as 12573−1111=11462. The user randomly enters the random don't care field as 43509. Hence the password becomes 1146243509. This random don't care field is a don't care field for the present instance of the password. The password authentication algorithm just ignores this field for the current instantiation and just stores this value for the creation of the random-hysteresis field in a future instantiation of the password. Similarly the random-hysteresis field of the next instance of the password is calculated as 43509−1111=42398. In this instance the user enters the random don't care field as 34524, which is randomly selected number and hence the password becomes 4239834524. A similar procedure is followed for the creation of the next instance of the password. In this case the user has to remember the random don't care field, which he has entered in a previous instance of the password and the function to create the random-hysteresis field, both in this case are easier to remember. This password authentication provides additional security because of the highly random nature of the passwords generated. Also the hysteresis behavior provides additional security. At the same time the password generation is very simple. It is almost as simple as the case of static passwords.

Referring now to FIG. 5, a system for password entry and authentication is shown, comprising a user device 500 and a server 501. The user device has a data entry device 510, such as a keypad or a keyboard, it has a processor 511, a memory 512, a clock 513 and a network interface 514 connected to a network port 515. The server 501 has a processor 520, memory 521, a clock 522 and a network interface 523 connected to a network port 524. The network ports 515 and 514 are connected together through a network (not shown).

In operation, the user of the user device 500 establishes a communication with the server 501 and, in doing so, the server 501 challenges the user for a password. In so-challenging the user, the server 501 may convey to the user device 500 a key so that the user device 500 may return an encrypted password. The user of the user device 500 constructs the password and enters this through entry device 510. The user may be assisted in constructing the password by means of data stored in memory 512 and the time and date provided by clock 513 and the extent to which the user is so aided, in constructing the password, depends upon whether user device 500 is the only device through which the user enters passwords for this system. Upon entry of the password, processor 511 encrypts the password using the key provided by the server 501 and delivers the password through interface 514 to the server 501, where it is received at interface 523, decrypted by processor 520 and compared by processor 520 with master password data stored in memory location 521a and previous password data stored in memory location 521b. The previous password data can be the previous password or can include the time or date or place of entry of the previous password. Using the master password data and the previous password data, the microprocessor 520 constructs the expected password and performs a comparison between the decrypted received password and the locally-constructed password. If there is a match, an authentication message is sent back to user device 500, informing the user that authentication has been successful and providing access to the password-protected service (whether that is provided by server 501 or by some other system).

In authentication systems that require knowledge of the place of log-in, the server 501 can identify the location of the user 500 by means of the TCP/IP number of the port 515. The server 501 can perform a look-up of the TCP/IP number, identify the place name and perform a count of the number of letters in the place name to facilitate authentication.

Turning to FIG. 6, a process performed on the server 501 is illustrated. The process begins at step 600 where a server 501 is ready to receive a log-in from the user of user device 500. When the user performs a log-in, this is received in step 601 and this triggers two simultaneous operations. First, the time and/or place of log-in is recorded (step 602) in an event log in memory 521 of the server 501. Secondly, the process proceeds to step 603, where the master password and previous password are recalled from memory locations 521a and 521b respectively and time data for a previous login is recalled from the event log. Next, in step 604, the new password is constructed using the time and/or place data recorded in step 602 and using the master password and previous password recalled from step 603 and the time data from the event log. This newly-constructed password is compared at step 605 with the password newly-received from the user. If there is a match (step 606), the new password is recorded (step 607) in memory location 521b for future use and access is granted, in step 608. If, in step 606, there is no match, an error message is sent back to the user (step 610).

The user can be aided in the complex task of constructing the password using the clock 513 and/or the memory 512 of the user device 500. This is particularly useful if the system is arranged whereby the server 501 is always accessed from user device 500. Thus, the user can be prompted by the user device 500 to enter the appropriate data in the appropriate dynamic fields with history, static fields and dynamic fields without history. As a further facilitating feature, some or all of these fields can be automatically populated from data stored in memory 512. Thus, for example, the password can be broken down into parts that are exclusively to be memorized by the user, parts that the user must memorize how to construct and parts that are automatically constructed from memory 512 and/or from the clock 513.

In all cases, the encrypted password sent over the network is dynamic so that interception by an eavesdropper will not compromise security.

The devices 500 and 501 can be collapsed into a single device such as a laptop computer and the system can be used for password access to that stand-alone device.

A method of password generation and authentication has been described, together with various software algorithms for generating a password, a software program for authenticating a password and apparatus and a system for providing password-authenticated access to equipment and services. A first described embodiment uses only historic data from a previous password, while a second embodiment also uses event log data (e.g. time of last login) and current login data (e.g. place of current login). The invention so-described finds application in defense installations, where the highest level of security is expected, and where intermittent password verifications may be carried out during an activity, in which the password is different each time. The invention also finds application in electronic commerce transactions, where the feature of continuously-changing passwords has the advantage of providing enormously enhanced security. The invention described has the advantage that a password may be explicitly shared with another person with the guarantee that the recipient will be able to use the password only once.

A single processor or unit may fulfill the functions of several means recited in the claims. A single means recited may be fulfilled by several means in networked fashion. Where an element or step is described as comprising one or more elements or steps, the term “comprising” does not exclude other elements or steps. The indefinite article “a” or “an” does not exclude a plurality. Further modifications of the invention can be made by, and further advantages will be apparent to, one of ordinary skill in the art, within the scope of the invention.

1. A method of authenticating a password that is presentable in a series of instances and has a first set of fields (201, 203) and has a second field (113, 114, 202, 311, 313, 314), wherein the first set of fields comprises at least one of (a) a static field (105, 201 or 302) that does not change upon each instance of the password and (b) a dynamic field (101, 102, 203, 305 or 306) that changes with each instance of the password based upon extrinsic data, and wherein the second field is arranged to contain historic data that is a function of a preceding instance of authentication, the method comprising:
receiving a current presented instance of the password (110 or 310); and
performing a comparison operation (605) in which the second field (113, 114, 311, 313 or 314) of the current presented instance of the password is compared using data retained since a prior instance of authentication of the password.

2. A method according to claim 1, wherein the historic data is a function of a preceding password.

3. A method according to claim 1, wherein the historic data is a function of an event record of a preceding instance of authentication.

4. A method according to claim 1, wherein the first set of fields comprises a static field (201) and a dynamic field (203).

5. A method according to claim 4, wherein, for the dynamic field, the step of performing a comparison operation comprises receiving extrinsic data in the form of date and/or time and/or place data and/or internet protocol address of a client machine.

6. A method according to claim 1, further comprising, upon successful comparison, retaining data for purposes of comparison of a next instance of the password.

7. A method according to claim 6, wherein the data retained (602) comprises one of the date and the time of receipt of the instance of the current presented instance of the password.

8. A method according to claim 6, wherein the data retained (602) is derived from the place of receipt of the instance of the current presented instance of the password.

9. A method according to claim 6, wherein the data retained comprises at least a part of the current presented instance of the password.

10. A method according to claim 1, wherein the step of comparing comprises:
generating (604) at least the second field of a generated instance of the password; and
comparing (605) the second field of the current presented instance of the password with the second field of the generated instance of the password.

11. A method according to claim 1, in which the password further has a third field containing pseudo-random data.

12. A method according to claim 11, in which the pseudo-random data is input by the user.

13. A method according to claim 11, in which the data retained is the contents of the third field.

14. A method according to claim 6, comprising retaining the contents of the third field.

15. Apparatus for receiving and authenticating a password that is presentable in a series of instances and has a first set of fields (201, 203) and has a second field (202), wherein the first set of fields comprises at least one of (a) a static field (201) that does not change upon each instance of the password and (b) a dynamic field (203) that changes with each instance of the password based upon extrinsic data, and wherein the second field (202) is arranged to contain historic data that is a function of a preceding instance of authentication, the apparatus comprising:
input means (500) for inputting a current presented instance of the password; and
comparison means (501) for performing a comparison operation in which the second field of the current presented instance of the password is compared using data retained since a prior instance of authentication of the password.

16. Apparatus according to claim 15, wherein the historic data is a function of a preceding password.

17. A data carrier having stored thereon instructions and data which, when loaded into the memory (521) of a suitable computer (501), and when presented with a current presented instance of a password that is presentable in a series of instances and has a first set of fields (201, 203) and has a second field (202), wherein the first set of fields comprises at least one of (a) a static field (201) that does not change upon each instance of the password and (b) a dynamic field (203) that changes with each instance of the password based upon extrinsic data, and wherein the second field (202) is arranged to contain data that is a function of a preceding instance of authentication, cause the computer to:
perform a comparison operation (605) in which the second field of the current presented instance of the password is compared using data retained since a prior instance of authentication of the password.
